(19) United States
(12) Patent Application Publication
(10) Pub. No.: US 2022/0344725 A1
(43) Pub. Date: Oct. 27, 2022

(54) NEGATIVE ELECTRODE FOR SECONDARY BATTERY, AND SECONDARY BATTERY

(71) Applicant: MURATA MANUFACTURING CO., LTD., Kyoto (JP)

(72) Inventor: Takaaki MATSUI, Kyoto (JP)

(21) Appl. No.: 17/859,415

(22) Filed: Jul. 7, 2022

Related U.S. Application Data
(63) Continuation of application No. PCT/JP2020/042440, filed on Nov. 13, 2020.

(30) Foreign Application Priority Data
Jan. 15, 2020 (JP) 2020-004501

(51) Int. Cl. H01M 10/0587; H01M 10/0525

(52) U.S. Cl. CPC H01M 10/0587; H01M 10/0525

(57) ABSTRACT

A secondary battery includes a positive electrode, a negative electrode, and an electrolytic solution. The negative electrode includes a negative electrode current collector and a negative electrode active material layer. The negative electrode includes: a one-side-provision part in which the negative electrode active material layer is provided only on one of opposite sides of the negative electrode current collector; and a both-side-provision part which is adjacent to the one-side-provision part, and in which the negative electrode active material layer is provided on each of the opposite sides of the negative electrode current collector. A first volume density of the negative electrode active material layer in the one-side-provision part is higher than a second volume density of the negative electrode active material layer in the both-side-provision part.

### CROSS REFERENCE TO RELATED APPLICATIONS

The present application is a continuation of PCT patent application no. PCT/JP2020/042440, filed Nov. 13, 2020, which claims priority to Japanese patent application no. JP 2020-004501, filed Jan. 15, 2020, the entire contents of which are being incorporated herein by reference.

### BACKGROUND

The present technology relates to a negative electrode for a secondary battery, and a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolytic solution which is a liquid electrolyte.

A configuration of the secondary battery influences a battery characteristic and has therefore been considered in various ways. Specifically, a density of a negative electrode active material layer in opposite end parts in a width direction is set to be lower than a density of the negative electrode active material layer in a central part in the width direction in order to reduce stress in the opposite end parts in the width direction of the negative electrode. In order to prevent occurrence of a wrinkle on an electrode due to stress applied to a boundary between a coating area and a non-coating area, a thickness of the coating area is gradually reduced toward the non-coating area, thereby gradually reducing a density of the coating area.

### SUMMARY

The present technology relates to a negative electrode for a secondary battery, and a secondary battery.

Although consideration has been given in various ways to improve a battery characteristic of a secondary battery, a cyclability characteristic of the secondary battery is not sufficient yet. Accordingly, there is still room for improvement in terms thereof.

The present technology has been made in view of such an issue and relates to providing a negative electrode for a secondary battery, and a secondary battery that are each able to achieve a superior cyclability characteristic according to an embodiment.

A negative electrode for a secondary battery according an embodiment includes a negative electrode current collector and a negative electrode active material layer. The negative electrode includes: a one-side-provision part in which the negative electrode active material layer is provided only on one of opposite sides of the negative electrode current collector; and a both-side-provision part which is adjacent to the one-side-provision part, and in which the negative electrode active material layer is provided on each of the opposite sides of the negative electrode current collector. A first volume density of the negative electrode active material layer in the one-side-provision part is higher than a second volume density of the negative electrode active material layer in the both-side-provision part.

A secondary battery according to an embodiment includes a positive electrode, a negative electrode, and an electrolytic solution. The negative electrode has a configuration similar to a configuration of the negative electrode for a secondary battery according to an embodiment.

According to the negative electrode for a secondary battery, or the secondary battery, in an embodiment, the negative electrode for a secondary battery (or the negative electrode) includes the one-side-provision part and the both-side-provision part. The first volume density of the negative electrode active material layer in the one-side-provision part is higher than the second volume density of the negative electrode active material layer in the both-side-provision part. Accordingly, it is possible to achieve a superior cyclability characteristic.

Note that effects of the present technology are not necessarily limited to those described herein and may include any of a series of suitable effects in relation to the present technology.

### BRIEF DESCRIPTION OF THE FIGURES

FIG. 1 is a perspective view of a configuration of a secondary battery according to an embodiment.

FIG. 2 is a schematic sectional view of a configuration of a battery device illustrated in FIG. 1.

FIG. 3 is another schematic sectional view of the configuration of the battery device illustrated in FIG. 1.

FIG. 4 is an enlarged sectional view of the configuration of the battery device illustrated in FIG. 1.

FIG. 5 is a sectional view of a configuration of a main part of a negative electrode illustrated in FIG. 3.

FIG. 6 is a sectional view for describing a process of manufacturing the secondary battery.

FIG. 7 is a sectional view for describing a process of manufacturing the secondary battery following FIG. 6.

FIG. 8 is a sectional view for describing a configuration of and a process of manufacturing a secondary battery according to a comparative example.

FIG. 9 is a block diagram illustrating a configuration of an application example of the secondary battery, which is a battery pack.

### DETAILED DESCRIPTION

The present application will be are described below in further detail with reference to the drawings according to an embodiment.

A description is given first of a secondary battery according to an embodiment. Note that a negative electrode for a secondary battery according to an embodiment is a portion (one component) of the secondary battery described herein. Accordingly, the negative electrode for the secondary battery is described below together with the secondary battery. Hereinafter, the negative electrode for the secondary battery is simply referred to as a “negative electrode”.

The secondary battery to be described here is a secondary battery that obtains a battery capacity using insertion and extraction of an electrode reactant, and includes a positive electrode, a negative electrode, and an electrolytic solution. In the secondary battery, to prevent unintentional precipitation of the electrode reactant on a surface of the negative electrode during charging, a charge capacity of the negative electrode is greater than a discharge capacity of the positive electrode. In other words, an electrochemical capacity per unit area of the negative electrode is greater than an electrochemical capacity per unit area of the positive electrode.

Although not particularly limited in kind, the electrode reactant is a light metal such as an alkali metal or an alkaline earth metal. Examples of the alkali metal include lithium, sodium, and potassium. Examples of the alkaline earth metal include beryllium, magnesium, and calcium.

Examples are given below of a case where the electrode reactant is lithium. A secondary battery that obtains a battery capacity using insertion and extraction of lithium is a so-called lithium-ion secondary battery. In the lithium-ion secondary battery, lithium is inserted and extracted in an ionic state.

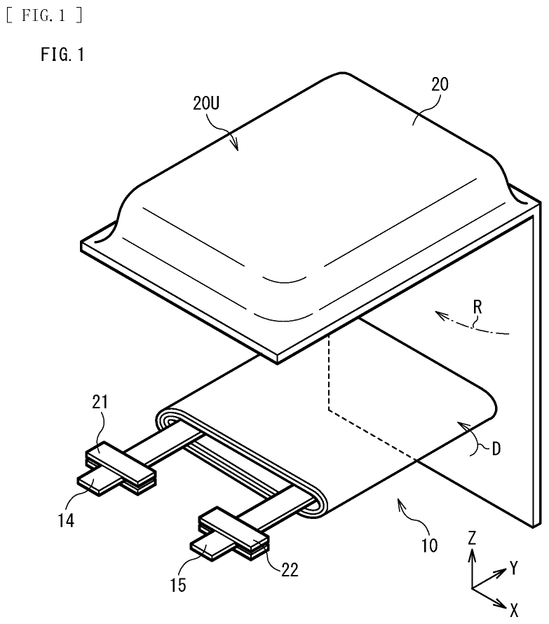

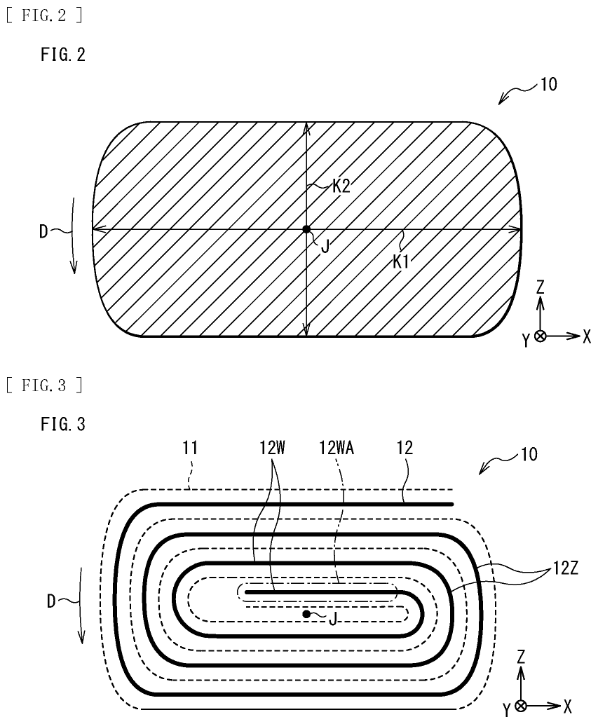

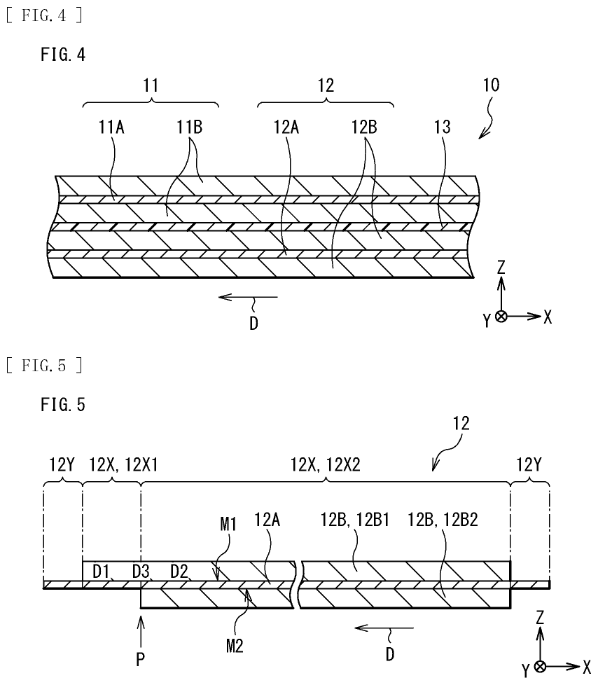

FIG. 1 illustrates a perspective configuration of the secondary battery. FIGS. 2 and 3 each schematically illustrate a sectional configuration of a battery device 10 illustrated in FIG. 1. FIG. 4 illustrates an enlarged sectional configuration of the battery device 10 illustrated in FIG. 1.

Note that FIG. 1 illustrates a state in which the battery device 10 and an outer package film 20 are separated away from each other. FIG. 2 illustrates a section of the battery device 10 intersecting a winding axis J extending in a Y-axis direction. FIG. 3 illustrates each of a positive electrode 11 and a negative electrode 12 in a linear shape to make respective winding states of the positive electrode 11 and the negative electrode 12 easy to understand. In each of FIGS. 2 and 3, an aspect ratio, i.e., a ratio between a length of a major axis K1 and a length of a minor axis K2, of the battery device 10 is adjusted in comparison with FIG. 1 to simplify the illustration. FIG. 4 illustrates only respective portions of the positive electrode 11, the negative electrode 12, and a separator 13.

As illustrated in FIG. 1, the secondary battery includes the battery device 10, the outer package film 20, a positive electrode lead 14, and a negative electrode lead 15. The battery device 10 is contained inside the outer package film 20. The positive electrode lead 14 and the negative electrode lead 15 are led out in a common direction from inside to outside the outer package film 20.

The secondary battery described here is a secondary battery of a laminated-film type. The secondary battery of the laminated-film type includes an outer package member having flexibility or softness, that is, the outer package film 20, as an outer package member to contain the battery device 10.

The outer package film 20 is a single film-shaped member and is foldable in a direction of an arrow R (a dash-dotted line), as illustrated in FIG. 1. The outer package film 20 contains the battery device 10 as described above, and thus contains the positive electrode 11, the negative electrode 12, and an electrolytic solution. The outer package film 20 has a depression part 20U to place the battery device 10 therein. The depression part 20U is a so-called deep drawn part.

Specifically, the outer package film 20 is a three-layered laminated film including a fusion-bonding layer, a metal layer, and a surface protective layer that are stacked in this order from an inner side. In a state in which the outer package film 20 is folded, outer edges of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 20 is not particularly limited in configuration or the number of layers, and may be single-layered or two-layered, or may include four or more layers.

A sealing film 21 is interposed between the outer package film 20 and the positive electrode lead 14. A sealing film 22 is interposed between the outer package film 20 and the negative electrode lead 15. The sealing films 21 and 22 are members that each prevent unintentional entry of outside air into the outer package film 20, and each include one or more of polymer compounds, including polyolefin, that have adherence to both the positive electrode lead 14 and the negative electrode lead 15. Examples of the polyolefin include polyethylene, polypropylene, modified polyethylene, and modified polypropylene. Note that the sealing film 21, the sealing film 22, or both may be omitted.

As illustrated in FIGS. 1 to 4, the battery device 10 includes the positive electrode 11, the negative electrode 12, the separator 13, and the electrolytic solution (not illustrated) which is a liquid electrolyte. The positive electrode 11, the negative electrode 12, and the separator 13 are each impregnated with the electrolytic solution.

As illustrated in FIGS. 1, 3, and 4, the battery device 10 is a structure in which the positive electrode 11 and the negative electrode 12 are wound in a winding direction D with the separator 13 interposed therebetween, and is a so-called wound electrode body. More specifically, in the battery device 10 which is the wound electrode body, the positive electrode 11 and the negative electrode 12 are stacked on each other with the separator 13 interposed therebetween, and the stack of the positive electrode 11, the negative electrode 12, and the separator 13 is wound about the winding axis J in the winding direction D. In order to simplify the illustration, FIG. 3 illustrates the positive electrode 11 in the linear shape using a thin dashed line and the negative electrode 12 in the linear shape using a thick solid line. FIG. 3 omits illustration of the separator 13.

As illustrated in FIG. 2, a section of the battery device 10 intersecting the winding axis J, that is, a section of the battery device 10 along an XZ plane, has an elongated shape defined by the major axis K1 and the minor axis K2, and more specifically, has an elongated, generally elliptical shape. The major axis K1 is an axis (a horizontal axis) that extends in an X-axis direction and has a relatively large length. The minor axis K2 is an axis (a vertical axis) that extends in the Y-axis direction intersecting the X-axis direction and has a relatively small length.

As illustrated in FIG. 4, the positive electrode 11 includes a positive electrode current collector 11A, and two positive electrode active material layers 11B provided on respective opposite sides of the positive electrode current collector 11A.

The positive electrode current collector 11A includes one or more of electrically conductive materials including, without limitation, a metal material. Examples of the metal material include aluminum, nickel, and stainless steel. The positive electrode active material layer 11B includes one or more of positive electrode active materials into which lithium is insertable and from which lithium is extractable. Note that the positive electrode active material layer 11B may further include, for example, a positive electrode binder and a positive electrode conductor.

Although not particularly limited in kind, the positive electrode active material is specifically a lithium-containing compound such as a lithium-containing transition metal compound. The lithium-containing transition metal compound includes lithium and one or more transition metal elements, and may further include one or more other elements. The other elements may be any elements other than transition metal elements, and are not particularly limited in kind. Specifically, however, the other elements are elements belonging to groups 2 to 15 in the long period periodic table of elements. Examples of the lithium-containing transition metal compound include an oxide, a phosphoric acid compound, a silicic acid compound, and a boric acid compound.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Specific examples of the phosphoric acid compound include LiFePO₄, LiMnPO₄, LiFe_{0.5}Mn_{0.5}PO₄, and LiFe_{0.3}Mn_{0.7}PO₄.

The positive electrode binder includes one or more of materials including, without limitation, a synthetic rubber and a polymer compound. Examples of the synthetic rubber include a styrene-butadiene-based rubber, a fluorine-based rubber, and ethylene propylene diene. Examples of the polymer compound include polyvinylidene difluoride, polyimide, and carboxymethyl cellulose.

The positive electrode conductor includes one or more of electrically conductive materials including, without limitation, a carbon material. Examples of the carbon material include graphite, carbon black, acetylene black, and Ketjen black. The electrically conductive material may be a metal material or a polymer compound, for example.

Note that the positive electrode 11 may include a part corresponding to a pair of non-provision parts 12Y to be described later. That is, an end part on an inner side of winding of the positive electrode 11 in the winding direction D and an end part on an outer side of the winding of the positive electrode 11 in the winding direction D are each provided with no positive electrode active material layer 11B on the opposite sides of the positive electrode current collector 11A. Thus, the positive electrode current collector 11A may be exposed at these end parts.

As illustrated in FIG. 4, the negative electrode 12 includes a negative electrode current collector 12A, and two negative electrode active material layers 12B provided on respective opposite sides of the negative electrode current collector 12A.

The negative electrode current collector 12A includes one or more of electrically conductive materials including, without limitation, a metal material. Examples of the metal material include copper, aluminum, nickel, and stainless steel. The negative electrode active material layer 12B includes one or more of negative electrode active materials into which lithium is insertable and from which lithium is extractable. Note that the negative electrode active material layer 12B may further include, for example, a negative electrode binder and a negative electrode conductor. Details of the negative electrode binder are similar to those of the positive electrode binder. Details of the negative electrode conductor are similar to those of the positive electrode conductor.

The negative electrode active material is not particularly limited in kind, and specific examples thereof include a carbon material and a metal-based material. Examples of the carbon material include graphitizable carbon, non-graphitizable carbon, and graphite. Examples of the graphite include natural graphite and artificial graphite. The metal-based material is a material that includes one or more elements among metal elements and metalloid elements that are each able to form an alloy with lithium. Examples of such metal elements and metalloid elements include silicon and tin. The metal-based material may be a simple substance, an alloy, a compound, a mixture of two or more thereof, or a material including two or more phases thereof.

Specific examples of the metal-based material include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≤2), LiSiO, SnO_{w} (0<w≤2), SnSiO₃, LiSnO, and Mg₂Sn. Note that “v” of SiOᵥ may satisfy 0.2<v<1.4.

A method of forming the negative electrode active material layer 12B is not particularly limited, and specifically, one or more methods are selected from among a coating method, a vapor-phase method, a liquid-phase method, a thermal spraying method, a firing (sintering) method, and other methods.

Note that a portion of the negative electrode active material layer 12B is not provided on each of opposite sides of the negative electrode current collector 12A, but is provided only on one of the opposite sides of the negative electrode current collector 12A. A detailed configuration of the above-described negative electrode 12 will be described later with reference to FIG. 5.

The separator 13 is an insulating porous film interposed between the positive electrode 11 and the negative electrode 12 as illustrated in FIG. 4, and allows lithium ions to pass therethrough while preventing a contact between the positive electrode 11 and the negative electrode 12.

The separator 13 includes one or more of polymer compounds including, without limitation, polytetrafluoroethylene, polypropylene, and polyethylene. The separator 13 may be a single-layer film including one porous film, or may be a multi-layer film including one or more porous films that are stacked on each other.

The electrolytic solution includes a solvent and an electrolyte salt.

The solvent includes one or more of non-aqueous solvents (organic solvents). The electrolytic solution including a non-aqueous solvent is a so-called non-aqueous electrolytic solution. Examples of the non-aqueous solvent include esters and ethers. More specific examples of the non-aqueous solvent include a carbonic-acid-ester-based compound, a carboxylic-acid-ester-based compound, and a lactone-based compound.

Examples of the carbonic-acid-ester-based compound include a cyclic carbonic acid ester and a chain carbonic acid ester. Examples of the cyclic carbonic acid ester include ethylene carbonate and propylene carbonate. Examples of the chain carbonic acid ester include dimethyl carbonate, diethyl carbonate, and methyl ethyl carbonate. Examples of the carboxylic-acid-ester-based compound include ethyl acetate, ethyl propionate, and ethyl trimethyl acetate. Examples of the lactone-based compound include γ-butyrolactone and γ-valerolactone. Examples of the ethers other than the lactone-based compounds described above include 1,2-dimethoxy ethane, tetrahydrofuran, 1,3-dioxolane, and 1,4-dioxane.

Further, examples of the non-aqueous solvent include an unsaturated cyclic carbonic acid ester, a halogenated carbonic acid ester, a sulfonic acid ester, a phosphoric acid ester, an acid anhydride, a nitrile compound, and an isocyanate compound. A reason for this is that chemical stability of the electrolytic solution improves.

Specific examples of the unsaturated cyclic carbonic acid ester include vinylene carbonate, vinylethylene carbonate, and methylene ethylene carbonate. Examples of the halogenated carbonic acid ester include monofluoroethylene carbonate and difluoroethylene carbonate. Examples of the sulfonic acid ester include 1,3-propane sultone and 1,3-propene sultone. Examples of the phosphoric acid ester include trimethyl phosphate. Examples of the acid anhydride include a cyclic carboxylic acid anhydride, a cyclic disulfonic acid anhydride, and a cyclic carboxylic acid sulfonic acid anhydride. Examples of the cyclic carboxylic acid anhydride include a succinic acid anhydride, a glutaric acid anhydride, and a maleic acid anhydride. Examples of the cyclic disulfonic acid anhydride include an ethane disulfonic acid anhydride and a propane disulfonic acid anhydride. Examples of the cyclic carboxylic acid sulfonic acid anhydride include a sulfobenzoic acid anhydride, a sulfopropionic acid anhydride, and a sulfobutyric acid anhydride. Examples of the nitrile compound include acetonitrile, acrylonitrile, malononitrile, succinonitrile, glutaronitrile, adiponitrile, sebaconitrile, and phthalonitrile. Examples of the isocyanate compound include hexamethylene diisocyanate.

The electrolyte salt includes one or more of light metal salts including, without limitation, a lithium salt. Examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), and lithium bis(oxalato)borate (LiB(C₂O₄)₂). Although not particularly limited, a content of the electrolyte salt is specifically within a range from 0.3 mol/kg to 3.0 mol/kg both inclusive with respect to the solvent. A reason for this is that a high ionic conductivity is obtainable.

The positive electrode lead 14 is coupled to the positive electrode 11 (the positive electrode current collector 11A), and the negative electrode lead 15 is coupled to the negative electrode 12 (the negative electrode current collector 12A). The positive electrode lead 14 includes one or more of electrically conductive materials including, without limitation, aluminum. The negative electrode lead 15 includes one or more of electrically conductive materials including, without limitation, copper, nickel, and stainless steel. The positive electrode lead 14 and the negative electrode lead 15 each have a shape such as a thin plate shape or a meshed shape.

The number of the positive electrode leads 14 is not particularly limited, and may thus be one, or two or more. The number of the negative electrode leads 15 is not particularly limited, and may thus be one, or two or more. If the number of the positive electrode leads 14 and the number of the negative electrode leads 15 are each two or more, in particular, the secondary battery decreases in electrical resistance.

FIG. 5 illustrates a sectional configuration of a main part of the negative electrode 12 illustrated in FIG. 3, and indicates a section corresponding to the section illustrated in FIG. 4. In FIG. 5, the left side indicates the inner side of the winding in the winding direction D, and the right side indicates the outer side of the winding in the winding direction D. In the following description, the respective illustrations of FIGS. 1 to 4 described already will be referenced where appropriate.

As illustrated in FIG. 5, the negative electrode current collector 12A extends in the winding direction D. The negative electrode current collector 12A is a plate-shaped member including the electrically conductive material such as the metal material described above, and thus has a pair of surfaces (a first surface M1 and a second surface M2) facing away from each other. In a case where the electrically conductive material is the metal material, the negative electrode current collector 12A may include, without limitation, a metal foil.

Here, the negative electrode active material layer 12B is provided only on a portion of the negative electrode current collector 12A, more specifically, only in a middle region of the negative electrode current collector 12A in the winding direction D. Thus, the negative electrode 12 includes: a provision part 12X in which the negative electrode active material layer 12B is provided on the negative electrode current collector 12A; and two non-provision parts 12Y in which no negative electrode active material layer 12B is provided on the negative electrode current collector 12A.

The provision part 12X is positioned in the middle of the negative electrode 12 in the winding direction D, and is a part in which the negative electrode active material layer 12B is provided on the first surface M1, on the second surface M2, or on each of the first surface M1 and the second surface M2. The provision part 12X includes: the negative electrode active material layer 12B provided on the first surface M1, that is, a first negative electrode active material layer 12B1; and the negative electrode active material layer 12B provided on the second surface M2, that is, a second negative electrode active material layer 12B2.

One of the two non-provision parts 12Y is positioned at one end of the negative electrode 12 in the winding direction D, and is a part in which no negative electrode active material layer 12B is provided either on the first surface M1 or on the second surface M2. The other of the two non-provision parts 12Y is positioned at the other end of the negative electrode 12 in the winding direction D, and is a part in which no negative electrode active material layer 12B is provided either on the first surface M1 or on the second surface M2. That is, in each of the two non-provision parts 12Y, the first surface M1 and the second surface M2 are not covered with the negative electrode active material layers 12B (the first negative electrode active material layer 12B1 and the second negative electrode active material layer 12B2). Thus, the negative electrode current collector 12A is exposed in each of the two non-provision parts 12Y.

A length (a dimension in the winding direction D) of each of the two non-provision parts 12Y, that is, a length over which the negative electrode current collector 12A is exposed on each of the first surface M1 and the second surface M2, is not particularly limited, and may thus be freely set. Specifically, owing to the fact that the negative electrode 12 is wound, the length of each of the two non-provision parts 12Y may be a length corresponding to a winding length of less than one wind of the negative electrode 12, or a length corresponding to a winding length of more than or equal to the one wind of the negative electrode 12.

In particular, the provision part 12X includes: a one-side-provision part 12X1 in which the negative electrode active material layer 12B is provided only on one of the opposite sides (the first surface M1) of the negative electrode current collector 12A; and a both-side-provision part 12X2 in which the negative electrode active material layer 12B is provided on each of the opposite sides (the first surface M1 and the second surface M2) of the negative electrode current collector 12A.

In the one-side-provision part 12X1, the first negative electrode active material layer 12B1 is provided on the first surface M1, whereas the second negative electrode active material layer 12B2 is not provided on the second surface M2. Accordingly, in the one-side-provision part 12X1: the first surface M1 is covered with the first negative electrode active material layer 12B1, and the negative electrode current collector 12A is thus not exposed on the first surface M1; whereas the second surface M2 is not covered with the second negative electrode active material layer 12B2, and the negative electrode current collector 12A is thus exposed on the second surface M2.

A length (a dimension in the winding direction D) of the one-side-provision part 12X1, that is, a length over which the negative electrode current collector 12A is exposed on the second surface M2, is not particularly limited, and may thus be freely set. However, the length of the one-side-provision part 12X1 is preferably sufficiently smaller than a length of the both-side-provision part 12X2. A reason for this is to secure a battery capacity by making an area where the positive electrode 11 (the positive electrode active material layer 11B) and the negative electrode 12 (the negative electrode active material layer 12B) are opposed to each other as large as possible.

The both-side-provision part 12X2 is adjacent to the one-side-provision part 12X1. More specifically, the both-side-provision part 12X2 is adjacent to the one-side-provision part 12X1 at a position (an adjacent position P) corresponding to an edge on the inner side of the winding of the second negative electrode active material layer 12B2 in the winding direction D.

In the both-side-provision part 12X2, the first negative electrode active material layer 12B1 is provided on the first surface M1, and the second negative electrode active material layer 12B2 is provided on the second surface M2. Accordingly, in the both-side-provision part 12X2: the first surface M1 is covered with the first negative electrode active material layer 12B1, and the negative electrode current collector 12A is thus not exposed on the first surface M1; and the second surface M2 is covered with the second negative electrode active material layer 12B2, and the negative electrode current collector 12A is thus not exposed on the second surface M2.

The first negative electrode active material layer 12B1 in the one-side-provision part 12X1 and the first negative electrode active material layer 12B1 in the both-side-provision part 12X2 are formed in the same process, and are thus integrated with each other. However, the first negative electrode active material layer 12B1 in the one-side-provision part 12X1 and the first negative electrode active material layer 12B1 in the both-side-provision part 12X2 may be formed in separate processes, and may thus be separated from each other.

Here, the one-side-provision part 12X1 is positioned in an end part on the inner side of the winding of the negative electrode 12 in the winding direction D. Accordingly, in the end part on the inner side of the winding of the negative electrode 12, the second negative electrode active material layer 12B2 is located back toward the outer side of the winding as compared with the first negative electrode active material layer 12B1 in order to provide the one-side-provision part 12X1 and the both-side-provision part 12X2. As a result, the negative electrode 12 includes the non-provision part 12Y, the provision part 12X (the one-side-provision part 12X1), the provision part 12X (the both-side-provision part 12X2), and the non-provision part 12Y disposed in this order from the inner side of the winding to the outer side of the winding in the winding direction D. In other words, the one-side-provision part 12X1 is disposed on the inner side of the winding as compared with the both-side-provision part 12X2.

The end part on the outer side of the winding of the negative electrode 12 in the winding direction D has no one-side-provision part 12X1, and the both-side-provision part 12X2 is thus adjacent to the non-provision part 12Y.

Here, the section of the battery device 10 has the elongated shape defined by the major axis K1 and the minor axis K2, as described above. Accordingly, as illustrated in FIGS. 2 and 3, the negative electrode 12 includes multiple extending parts 12W extending in a direction of the major axis K1, and multiple curved parts 12Z coupling the multiple extending parts 12W to each other. The extending part 12W extends substantially linearly, i.e., in a flat shape, toward the direction of the major axis K1 (here, in the X-axis direction). The curved part 12Z extends generally in a direction (here, the Y-axis direction) intersecting the extending direction of the extending part 12W and is curved in such a manner as to draw a convex arc bulging in a direction away from the winding axis J.

Among the multiple extending parts 12W, the extending part 12W positioned on the innermost side of the winding (an innermost wind) is an innermost wind extending part 12WA (a negative electrode extending part). In other words, the negative electrode 12 includes the innermost wind extending part 12WA extending in the direction of the major axis K1 in the end part on the inner side of the winding in the winding direction D. The innermost wind extending part 12WA includes the above-described one-side-provision part 12X1, and the one-side-provision part 12X1 is thus provided in the innermost wind extending part 12WA.

The first negative electrode active material layer 12B1 in the one-side-provision part 12X1 may be disposed on a side closer to the winding axis J than the negative electrode current collector 12A, or may be disposed on a side farther from the winding axis J than the negative electrode current collector 12A.

Here, in the negative electrode 12 including the one-side-provision part 12X1 and the both-side-provision part 12X2, volume densities (g/cm³) of the negative electrode active material layer 12B are set in such a manner as to differ from each other depending on locations. Specifically, a volume density D1, i.e., a first volume density, of the negative electrode active material layer 12B (the first negative electrode active material layer 12B1) in the one-side-provision part 12X1 is higher than a volume density D2, i.e., a second volume density, of the negative electrode active material layer 12B (the first negative electrode active material layer 12B1 and the second negative electrode active material layer 12B2) in the both-side-provision part 12X2.

A reason why the volume density D1 is higher than the volume density D2 is that, even if the negative electrode active material layer 12B (in particular, the first negative electrode active material layer 12B1 in the one-side-provision part 12X1) expands and contracts upon charging and discharging, a conductive path is prevented from being lost easily inside the negative electrode active material layer 12B, and occurrence of local precipitation of lithium metal due to the loss of the conductive path is suppressed. As a result, the conductive path is easily maintained while the precipitation of lithium metal is suppressed in the negative electrode active material layer 12B even if charging and discharging are repeated, and this suppresses reduction in a discharge capacity. Details of why the advantages described here are achieved will be described later.

A volume density D3, i.e., a third volume density, of the negative electrode active material layer 12B (the first negative electrode active material layer 12B1) at the adjacent position P is not particularly limited. That is, as long as the volume density D1 is higher than the volume density D2, the volume density D3 may be freely set.

In particular, the volume density D3 is preferably higher than or equal to the volume density D2. A reason for this is that the volume density D3 is secured at the adjacent position P, thus further preventing the conductive path from being lost easily and further suppressing the occurrence of local precipitation of lithium metal upon charging and discharging. Another reason for this is that, in a process of fabricating the negative electrode 12 using a compression-molding process to be described later, it becomes easier to fabricate the negative electrode 12 in such a manner that the volume density D1 is higher than the volume density D2, thus making it possible to fabricate such a negative electrode 12 easily and stably.

In this case, the volume density D3 is more preferably lower than or equal to the volume density D1. A reason for this is that the volume densities D1 and D3 are sufficiently high with respect to the volume density D2, thus markedly preventing the conductive path from being lost easily and markedly suppressing the occurrence of local precipitation of lithium metal upon charging and discharging.

If the above-described relationship is established between the volume densities D1 and D2 (or the volume densities D1, D2, and D3), respective values of the volume densities D1, D2, and D3 are not particularly limited, and may thus be freely set. The respective values of the volume densities D1 to D3 are each rounded off to three decimal places. In particular, the volume density D2 is preferably within a range from 1.500 g/cm³ to 1.770 g/cm³ both inclusive. A reason for this is that a sufficient battery capacity is obtainable.

Here, an increase rate RD represented by Expression (1) is preferably greater than 0% and less than or equal to 3.0%. A reason for this is that, in a case where the volume density D1 is higher than the volume density D2, the relationship between the volume densities D1 and D2 is made appropriate, thus further preventing the conductive path from being lost easily and further suppressing the occurrence of local precipitation of lithium metal upon charging and discharging. The increase rate RD is a parameter indicating a rate of an increase of the volume density D1 over the volume density D2, and is a value rounded off to one decimal place.

RD=(D1/D2−1)×100 (1)

where:
RD is the increase rate (%);
D1 is the volume density (g/cm³) of the negative electrode active material layer 12B in the one-side-provision part 12X1; and
S2 is the volume density (g/cm³) of the negative electrode active material layer 12B in the both-side-provision part 12X2.

A procedure to measure each of the volume densities D1, D2, and D3 is as described below.

In a case of measuring the volume density D1, first, the negative electrode 12 is punched (or the negative electrode current collector 12A and the first negative electrode active material layer 12B1 are punched) in a circular shape having an outer diameter of 10 mm in a region which is: 10 mm or more away from a position of one end (the left end in FIG. 5) of the one-side-provision part 12X1 on the inner side of the winding toward the outer side of the winding; and 10 mm or more away from the adjacent position P toward the inner side of the winding.

Thereafter, a weight (g) and a thickness (cm) of the one-side-provision part 12X1 is determined using the circular negative electrode 12, thereby calculating the volume density (g/cm³) of the one-side-provision part 12X1. In this case, the weight of the one-side-provision part 12X1 is calculated by subtracting a weight of the non-provision part 12Y from a weight of the negative electrode 12, and the thickness of the one-side-provision part 12X1 is calculated by subtracting a thickness of the non-provision part 12Y from a thickness of the negative electrode 12. Further, the process from punching the circular negative electrode 12 to determining the volume density of the one-side-provision part 12X1 is repeated three times, thereby obtaining three volume densities.

Lastly, an average value of the three volume densities is calculated to be served as the volume density D1.

The procedure to measure the volume density D2 is similar to the procedure to measure the volume density D1 described above, except that the negative electrode 12 is punched (or the negative electrode current collector 12A, the first negative electrode active material layer 12B1, and the second negative electrode active material layer 12B2 are punched) in a circular shape in a region which is 10 mm or more away from the adjacent position P toward the outer side of the winding. In this case, a weight of the both-side-provision part 12X2 is calculated by subtracting the weight of the non-provision part 12Y from the weight of the negative electrode 12, and a thickness of the both-side-provision part 12X2 is calculated by subtracting the thickness of the non-provision part 12Y from the thickness of the negative electrode 12.

The procedure to measure the volume density D3 is similar to the procedure to measure the volume density D1 described above, except that the negative electrode 12 is punched in a circular shape in a region which is: within a range of less than 10 mm from the adjacent position P toward the outer side of the winding; and within a range of less than 10 mm from the adjacent position P toward the inner side of the winding.

However, in a case where the negative electrode 12 is punched (or the negative electrode current collector 12A and the first negative electrode active material layer 12B1 are punched) in the one-side-provision part 12X1, the weight of the one-side-provision part 12X1 is calculated by subtracting the weight of the non-provision part 12Y from the weight of the negative electrode 12, and the thickness of the one-side-provision part 12X1 is calculated by subtracting the thickness of the non-provision part 12Y from the thickness of the negative electrode 12, as described above. In contrast, in a case where the negative electrode 12 is punched (or the negative electrode current collector 12A, the first negative electrode active material layer 12B1, and the second negative electrode active material layer 12B2 are punched) in the both-side-provision part 12X2, the weight of the both-side-provision part 12X2 is calculated by subtracting the weight of the non-provision part 12Y from the weight of the negative electrode 12, and the thickness of the both-side-provision part 12X2 is calculated by subtracting the thickness of the non-provision part 12Y from the thickness of the negative electrode 12, as described above.

In a case of measuring each of the volume densities D1, D2, and D3, the negative electrode 12 is preferably punched at positions sufficiently distant from each other, for example, away from each other by 10 mm or more, in order to secure accuracy of measurement of each of the volume densities D1, D2, and D3. This prevents the respective values of the volume densities D1 and D3 from being the same easily, thereby making it easier to measure each of the volume densities D1 and D3 with high accuracy. This also prevents the respective values of the volume densities D2 and D3 from being the same easily, thereby making it easier to measure each of the volume densities D2 and D3 with high accuracy.

Upon charging the secondary battery, lithium is extracted from the positive electrode 11, and the extracted lithium is inserted into the negative electrode 12 via the electrolytic solution. Upon discharging the secondary battery, lithium is extracted from the negative electrode 12, and the extracted lithium is inserted into the positive electrode 11 via the electrolytic solution. Upon charging and discharging the secondary battery, lithium is inserted and extracted in an ionic state.

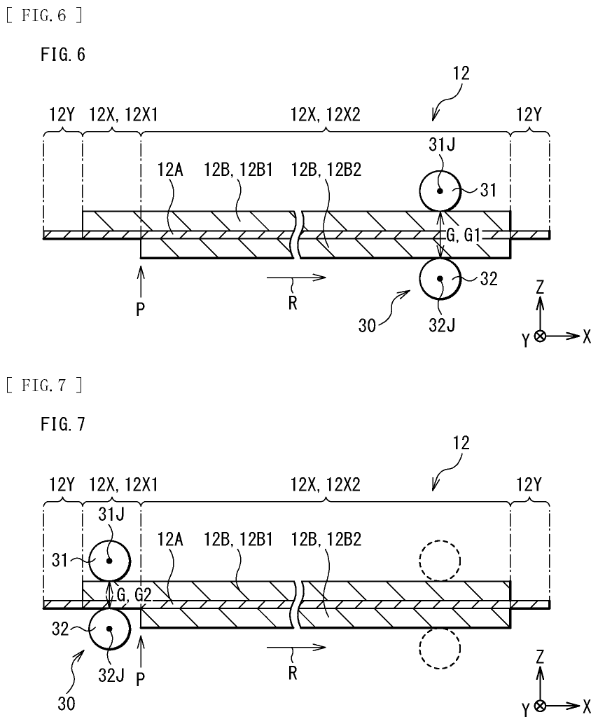

FIGS. 6 and 7 each illustrate a sectional configuration corresponding to the configuration illustrated in FIG. 5 to describe a process of manufacturing the secondary battery. FIGS. 6 and 7 each illustrate, together with the negative electrode 12 in the middle of fabrication, a roll pressing machine 30 to be used for performing a compression-molding process.

In a case of manufacturing the secondary battery, the positive electrode 11 and the negative electrode 12 are fabricated and the electrolytic solution is prepared, following which the secondary battery is assembled using the positive electrode 11, the negative electrode 12, and the electrolytic solution, according to a procedure to be described below. In the following description, the respective illustrations of FIGS. 1 to 5 described already will be referenced where appropriate.

First, the positive electrode active material is mixed with materials including, without limitation, the positive electrode binder and the positive electrode conductor on an as-needed basis to thereby obtain a positive electrode mixture. Thereafter, the positive electrode mixture is put into a solvent such as an organic solvent to thereby prepare a paste positive electrode mixture slurry. Lastly, the positive electrode mixture slurry is applied on opposite sides of the positive electrode current collector 11A to thereby form the positive electrode active material layers 11B. Thereafter, the positive electrode active material layers 11B may be compression-molded by means of a roll pressing machine. In this case, the positive electrode active material layers 11B may be heated. The positive electrode active material layers 11B may be compression-molded multiple times. In this manner, the positive electrode active material layers 11B are formed on the respective opposite sides of the positive electrode current collector 11A. Thus, the positive electrode 11 is fabricated.

In a case of fabricating the positive electrode 11, when the positive electrode 11 is wound together with the negative electrode 12 to fabricate a wound body as will be described later, a range over which the positive electrode active material layer 11B is formed is adjusted in such a manner that a portion of the positive electrode active material layer 11B is opposed to the entire negative electrode active material layer 12B with the separator 13 interposed therebetween.

First, the negative electrode active material is mixed with materials including, without limitation, the negative electrode binder and the negative electrode conductor on an as-needed basis to thereby obtain a negative electrode mixture. Thereafter, the negative electrode mixture is put into a solvent such as an organic solvent to thereby prepare a paste negative electrode mixture slurry.

Thereafter, the negative electrode mixture slurry is applied on the opposite sides (the first surface M1 and the second surface M2) of the negative electrode current collector 12A to thereby form the negative electrode active material layers 12B (the first negative electrode active material layer 12B1 and the second negative electrode active material layer 12B2). In this case, the negative electrode mixture slurry is applied to only a portion of the negative electrode current collector 12A to thereby form the provision part 12X and the pair of non-provision parts 12Y. In addition, a range over which the negative electrode mixture slurry is applied on the first surface M1 and a range over which the negative electrode mixture slurry is applied on the second surface M2 are made to be different from each other to thereby form the one-side-provision part 12X1 and the both-side-provision part 12X2. Thus, the negative electrode 12 is formed which includes the provision part 12X including the one-side-provision part 12X1 and the both-side-provision part 12X2, and the non-provision parts 12Y.

Lastly, as illustrated in FIGS. 6 and 7, the negative electrode active material layers 12B (the first negative electrode active material layer 12B1 and the second negative electrode active material layer 12B2) are compression-molded by means of the roll pressing machine 30 by conveying the negative electrode 12 in a conveyance direction R (a rightward direction in FIGS. 6 and 7).

The roll pressing machine 30 includes a pair of press rollers 31 and 32. The press rollers 31 and 32 are disposed in such a manner as to be opposed to each other with the negative electrode 12 interposed therebetween in a direction (a Z-axis direction) intersecting the conveyance direction R of the negative electrode 12.

The press roller 31 is a roller to be used to compression-mold the first negative electrode active material layer 12B1. The press roller 31 has a cylindrical three-dimensional shape extending in the Y-axis direction and is rotatable about a rotational axis 31J extending in the Y-axis direction. During the compression-molding process, the press roller 31 is pressed against the first negative electrode active material layer 12B1 while rotating about the rotational axis 31J.

The press roller 32 is a roller to be used to compression-mold the second negative electrode active material layer 12B2. The press roller 32 has a three-dimensional shape similar to that of the press roller 31 and is rotatable about a rotational axis 32J. During the compression-molding process, the press roller 32 is pressed against the first negative electrode active material layer 12B1 while rotating about the rotational axis 32J.

In particular, the press roller 32 is movable in the direction (the Z-axis direction) intersecting the conveyance direction R while rotating about the rotational axis 32J on an as-needed basis. In other words, the press roller 32 is movable in a direction away from the press roller 31 (a downward direction) as illustrated in FIG. 6, and in a direction approaching the press roller 32 (an upward direction) as illustrated in FIG. 7. This makes it possible to vary a distance G from the press roller 31 to the press roller 32, within a range from a relatively large distance G1 to a relatively small distance G2.

In the compression-molding process, as illustrated in FIG. 6, the press roller 32 moves in the direction away from the press roller 31 to thereby convey the negative electrode 12 in the conveyance direction R between the press rollers 31 and 32. The negative electrode 12 is conveyed in a state in which the press rollers 31 and 32 are disposed in such a manner that the distance G is set to the distance G1. In this case, the press rollers 31 and 32 sandwich the provision part 12X (the both-side-provision part 12X2) therebetween, and are each thus pressed against the both-side-provision part 12X2. As a result, the press roller 31 is pressed against the first negative electrode active material layer 12B1 to thereby compression-mold the first negative electrode active material layer 12B1, and the press roller 32 is pressed against the second negative electrode active material layer 12B2 to thereby compression-mold the second negative electrode active material layer 12B2.

As long as the both-side-provision part 12X2 is compression-moldable (or the first negative electrode active material layer 12B1 and the second negative electrode active material layer 12B2 are compression-moldable) by the press rollers 31 and 32, the distance G1 is not particularly limited, and may thus be freely set. That is, a pressing pressure of the press roller 31 with respect to the first negative electrode active material layer 12B1 may be freely set, and a pressing pressure of the press roller 32 with respect to the second negative electrode active material layer 12B2 may be freely set.

Thereafter, when each of the press rollers 31 and 32 reaches the adjacent position P or the vicinity thereof as a result of the negative electrode 12 being conveyed in the conveyance direction R, the press roller 32 moves in such a manner as to approach the press roller 31 as illustrated in FIG. 7. The distance G is thus changed from the distance G1 to the distance G2. In this case, the press rollers 31 and 32 sandwich the provision part 12X (the one-side-provision part 12X1) therebetween, and are each thus pressed against the one-side-provision part 12X1. As a result, the press roller 31 is pressed against the first negative electrode active material layer 12B1 to thereby compression-mold the first negative electrode active material layer 12B1, and the press roller 32 is pressed against the negative electrode current collector 12A (the second surface M2) to thereby support the negative electrode current collector 12A.

As long as the one-side-provision part 12X1 (or the first negative electrode active material layer 12B1) is compression-moldable by the press rollers 31 and 32, the distance G2 is not particularly limited, and may thus be freely set. That is, the pressing pressure of the press roller 31 with respect to the first negative electrode active material layer 12B1 may be freely set, and a contact pressure of the press roller 32 with respect to the negative electrode current collector 12A may be freely set.

In the compression-molding process, the distance G2 is set to be sufficiently smaller than the distance G1. This allows the one-side-provision part 12X1 (the first negative electrode active material layer 12B1) to be compression-molded more sufficiently than the both-side-provision part 12X2 (the first negative electrode active material layer 12B1 and the second negative electrode active material layer 12B2) by the press rollers 31 and 32. The volume density D1 of the negative electrode active material layer 12B (the first negative electrode active material layer 12B1) in the one-side-provision part 12X1 thus becomes higher than the volume density D2 of the negative electrode active material layer 12B (the first negative electrode active material layer 12B1 and the second negative electrode active material layer 12B2) in the both-side-provision part 12X2.

That is, in a case of compression-molding the one-side-provision part 12X1 using the press rollers 31 and 32, the press roller 31 is pressed against the first negative electrode active material layer 12B1 while the first negative electrode active material layer 12B1 is supported from behind by the press roller 32. The first negative electrode active material layer 12B1 is thus sufficiently compression-molded by the press roller 31. Accordingly, although the second negative electrode active material layer 12B2 is absent in the one-side-provision part 12X1, the first negative electrode active material layer 12B1 is compression-molded at a pressing pressure higher than a pressing pressure at which the both-side-provision part 12X2 is compression-molded. Thus, the volume density D1 becomes higher than the volume density D2.

The volume density D3 of the negative electrode active material layer 12B at the adjacent position P may be freely set by adjusting a condition such as a movement-start time, a movement-end time, a movement speed, or a movement time period of the press roller 32.

Specifically, if the press roller 32 moves in such a manner as to gradually approach the press roller 31 prior to reaching the adjacent position P, the pressing pressure gradually increases in the order of the both-side-provision part 12X2, the adjacent position P, and the one-side-provision part 12X1. Thus, the volume density D3 becomes higher than or equal to the volume density D2. Further, the volume density D3 becomes lower than or equal to the volume density D1 depending on the pressing pressure in the vicinity of the adjacent position P.

Thereafter, when the negative electrode 12 is further conveyed in the conveyance direction R, the press rollers 31 and 32 are detached from the negative electrode 12. The compression-molding process performed by means of the roll pressing machine 30 is thus completed.

Thus, the negative electrode active material layers 12B (the first negative electrode active material layer 12B1 and the second negative electrode active material layer 12B2) including the one-side-provision part 12X1 and the both-side-provision part 12X2 are formed on the respective opposite sides (the first surface M1 and the second surface M2) of the negative electrode current collector 12A in such a manner that the volume density D1 becomes higher than the volume density D2 to thereby fabricate the negative electrode 12.

### [Preparation of Electrolytic Solution]

The electrolyte salt is put into a solvent. The electrolyte salt is thereby dispersed or dissolved in the solvent. As a result, the electrolytic solution is prepared.

First, the positive electrode lead 14 is coupled to the positive electrode 11 (the positive electrode current collector 11A) by a method such as a welding method, and the negative electrode lead 15 is coupled to the negative electrode 12 (the negative electrode current collector 12A) by a method such as a welding method. Thereafter, the positive electrode 11 and the negative electrode 12 are stacked on each other with the separator 13 interposed therebetween, following which the stack of the positive electrode 11, the negative electrode 12, and the separator 13 is wound about the winding axis J in the winding direction D to thereby fabricate a wound body. In this case, the negative electrode 12 is wound in such a manner that the one-side-provision part 12X1 is positioned at the end part on the inner side of the winding. Thereafter, the wound body is pressed by means of, for example, a pressing machine, and is thereby shaped into an elongated shape in a section intersecting the winding axis J.

Thereafter, the wound electrode body is placed inside the depression part 20U and the outer package film 20 is folded, following which outer edges of two sides of the outer package film 20 (the fusion-bonding layer) are bonded to each other by a method such as a thermal-fusion-bonding method. The wound body is thereby contained in the pouch-shaped outer package film 20.

Lastly, the electrolytic solution is injected into the pouch-shaped outer package film 20, following which the outer edges of the remaining one side of the outer package film 20 (the fusion-bonding layer) are bonded to each other by a method such as a thermal-fusion-bonding method. In this case, the sealing film 21 is interposed between the outer package film 20 and the positive electrode lead 14, and the sealing film 22 is interposed between the outer package film 20 and the negative electrode lead 15. The wound body is thereby impregnated with the electrolytic solution. Thus, the battery device 10 is fabricated. In this manner, the battery device 10 is sealed in the pouch-shaped outer package film 20. The secondary battery is thus assembled.

The secondary battery is charged and discharged. Various conditions including an environment temperature, the number of times of charging and discharging (the number of cycles), and charging and discharging conditions may be freely chosen. This process forms a film on the surface of, for example, the negative electrode 12, to thereby bring the secondary battery into an electrochemically stable state. The secondary battery including the outer package film 20, that is, the secondary battery of the laminated-film type, is thus completed.

According to this secondary battery, the negative electrode 12 includes the one-side-provision part 12X1 and the both-side-provision part 12X2, and the volume density D1 of the negative electrode active material layer 12B in the one-side-provision part 12X1 is higher than the volume density D2 of the negative electrode active material layer 12B in the both-side-provision part 12X2. Accordingly, it is possible to achieve a superior cyclability characteristic for reasons described below.

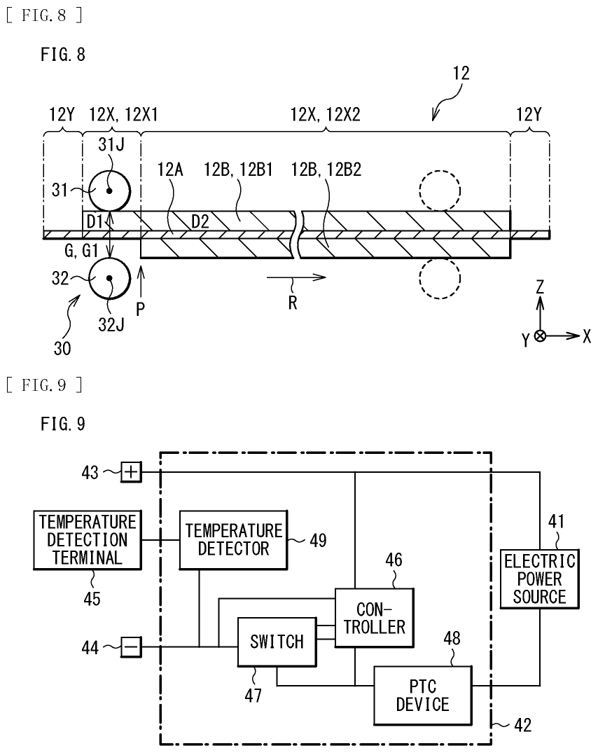

FIG. 8 illustrates a sectional configuration corresponding to the sectional configuration illustrated in FIG. 7 to describe a configuration of and a process of manufacturing a secondary battery according to a comparative example. As illustrated in FIG. 8, the secondary battery according to the comparative example has a configuration similar to the configuration of the secondary battery according to the present embodiment except that the volume density D1 is lower than the volume density D2, because the distance G is constant at the distance G1 due to the fact that the press roller 32 does not move during a process of compressing the negative electrode 12 by means of the roll pressing machine 30.

In the process of manufacturing the secondary battery (the process of compressing the negative electrode 12) according to the comparative example, the press roller 32 does not move in such a manner as to approach the press roller 31, as illustrated in FIG. 8. Accordingly, in a case of compression-molding the one-side-provision part 12X1 (the first negative electrode active material layer 12B1) by the press rollers 31 and 32, the press roller 32 is separated away from the one-side-provision part 12X1 due to absence of the second negative electrode active material layer 12B2. As a result, the press roller 31 comes into contact with the first negative electrode active material layer 12B1 in a state in which the first negative electrode active material layer 12B1 is not supported from behind by the press roller 32. The press roller 31 is thus prevented from being pressed against the first negative electrode active material layer 12B1 easily. This prevents the first negative electrode active material layer 12B1 from being compression-molded by the press roller 31 easily, which causes the volume density D1 to be lower than the volume density D2.

In a case where the volume density D1 becomes lower than the volume density D2, the conductive path is lost easily inside the negative electrode active material layer 12B and the local precipitation of lithium metal due to the loss of the conductive path easily occurs, when the negative electrode active material layer 12B (in particular, the first negative electrode active material layer 12B1 in the one-side-provision part 12X1) expands and contracts upon charging and discharging. As a result, when charging and discharging are repeated, not only is it difficult to maintain the conductive path in the negative electrode active material layer 12B, but also the precipitation of lithium metal is liable to occur.

Accordingly, the secondary battery of the comparative example tends to decrease in discharge capacity upon repeated charging and discharging, and thus has difficulty in achieving a superior cyclability characteristic.

In contrast, in the process of manufacturing the secondary battery (the process of compressing the negative electrode 12) according to the present embodiment, the press roller 32 moves in such a manner as to approach the press roller 31, as illustrated in FIG. 7. Accordingly, in a case of compression-molding the one-side-provision part 12X1 (the first negative electrode active material layer 12B1) by the press rollers 31 and 32, the press roller 32 comes into contact with the one-side-provision part 12X1 although the second negative electrode active material layer 12B2 is absent. Thus, the press roller 31 comes into contact with the first negative electrode active material layer 12B1 in the state in which the first negative electrode active material layer 12B1 is supported from behind by the press roller 32. This makes it easier for the press roller 31 to be pressed against the first negative electrode active material layer 12B1. As a result, the first negative electrode active material layer 12B1 is easily compression-molded by the press roller 31. Thus, the volume density D1 becomes higher than the volume density D2.

If the volume density D1 becomes higher than the volume density D2, the conductive path is easily secured inside the negative electrode active material layer 12B and the local precipitation of lithium metal due to the loss of the conductive path is suppressed, even if the negative electrode active material layer 12B (in particular, the first negative electrode active material layer 12B1 in the one-side-provision part 12X1) expands and contracts upon charging and discharging. As a result, the precipitation of lithium metal is suppressed easily while the conductive path is easily maintained when charging and discharging are repeated.

Accordingly, the secondary battery according to the present embodiment is prevented from being decreased in the discharge capacity easily even if charging and discharging are repeated, and thus has difficulty in achieving a superior cyclability characteristic.

In particular, the volume density D3 of the negative electrode active material layer 12B at the adjacent position P may be higher than or equal to the volume density D2. This makes it easier to maintain the conductive path and to suppress the precipitation of lithium metal upon charging and discharging. Accordingly, it is possible to achieve higher effects.

In this case, the volume density D3 may be lower than or equal to the volume density D1. This makes it markedly easier to maintain the conductive path and to suppress the precipitation of lithium metal upon charging and discharging. Accordingly, it is possible to achieve further higher effects.

Further, the volume density D2 may be within a range from 1.500 g/cm³ to 1.770 g/cm³ both inclusive. This helps to obtain a sufficient battery capacity. Accordingly, it is possible to achieve higher effects.

Further, the increase rate RD may be greater than 0% and less than or equal to 3.0%. This makes it easier to maintain the conductive path and to suppress the precipitation of lithium metal upon charging and discharging. Accordingly, it is possible to achieve higher effects.

Further, the negative electrode 12 may be wound, and the one-side-provision part 12X1 may be positioned in the end part on the inner side of the winding of the negative electrode 12 in the winding direction D. This allows a thickness of the one-side-provision part 12X1 to be small owing to a sufficient increase in the volume density D1, and thus makes it easier to reduce a level difference (a difference in height) between the one-side-provision part 12X1 and the both-side-provision part 12X2 in the end part on the inner side of the winding where the negative electrode 12 is wound more tightly. As a result, unintentional damage and breakage of the negative electrode 12 due to the level difference are suppressed, which allows the secondary battery to be charged and discharged stably. This makes it easier to suppress a decrease in the discharge capacity caused by the damage and the breakage of the negative electrode 12. Accordingly, it is possible to achieve higher effects.

In this case, the innermost wind extending part 12WA may include the one-side-provision part 12X1. This effectively reduces the level difference, which further makes it easier to suppress the damage and the breakage of the negative electrode 12. As a result, the decrease in the discharge capacity caused by the damage and the breakage of the negative electrode 12 is further suppressed. Accordingly, it is possible to achieve further higher effects.

Further, the secondary battery may include a lithium-ion secondary battery. This allows a sufficient battery capacity to be obtained stably by utilizing a lithium insertion phenomenon and a lithium extraction phenomenon. Accordingly, it is possible to achieve higher effects.

Next, a description is given of modifications of the above-described secondary battery according to an embodiment. The configuration of the secondary battery is appropriately modifiable as described below. Note that any two or more of the following series of modifications may be combined.

In FIG. 5, the one-side-provision part 12X1 is provided only in the end part on the inner side of the winding of the negative electrode 12 in the winding direction D; however, a position at which the one-side-provision part 12X1 is disposed is not particularly limited.

Specifically, although not illustrated here, the one-side-provision part 12X1 may be provided only in the end part on the outer side of the winding of the negative electrode 12, or may be provided on both the end part on the inner side of the winding of the negative electrode 12 and the end part on the outer side of the winding of the negative electrode 12. In these cases also, it is possible to achieve similar effects.

However, in order to suppress the issues of the unintentional damage and the unintentional breakage of the negative electrode 12 caused by the level difference in the end part on the inner side of the winding, the one-side-provision part 12X1 is preferably provided in the end part on the inner side of the winding of the negative electrode 12 as described above.

In FIG. 5, only the negative electrode 12 includes the one-side-provision part 12X1 and the both-side-provision part 12X2, and the volume density D1 is set to be higher than the volume density D2 only in the negative electrode 12.

However, although not specifically illustrated here, the positive electrode 11 may also include the one-side-provision part and the both-side-provision part, and may satisfy the above-described magnitude relationship between the volume densities. In this case also, it is possible to achieve similar effects.

However, in order to suppress the issues of the unintentional damage and the unintentional breakage of the negative electrode 12 caused by the level difference in the end part on the inner side of the winding as described above, the one-side-provision part 12X1 is preferably provided in the end part on the inner side of the winding of the negative electrode 12.

The separator 13 including a porous film is used. However, although not specifically illustrated here, a separator of a stacked type including a polymer compound layer may be used instead of the separator 13 including the porous film.

Specifically, the separator of the stacked type includes a porous layer including the porous film described above, and a polymer compound layer provided on one side or each of opposite sides of the porous layer. A reason for this is that adherence of the separator to each of the positive electrode 11 and the negative electrode 12 improves to suppress the occurrence of positional displacement of the battery device 10. This helps to prevent the secondary battery from easily swelling even if, for example, a decomposition reaction of the electrolytic solution occurs. The polymer compound layer includes a polymer compound such as polyvinylidene difluoride. A reason for this is that such a polymer compound has superior physical strength and is electrochemically stable.

Note that the porous layer, the polymer compound layer, or both may include one or more kinds of particles including, for example, inorganic particles and resin particles. A reason for this is that the particles dissipate heat upon heat generation by the secondary battery, and this improves heat resistance and safety of the secondary battery. The inorganic particles are not particularly limited in kind, and specifically inorganic materials including, without limitation, aluminum oxide (alumina), aluminum nitride, boehmite, silicon oxide (silica), titanium oxide (titania), magnesium oxide (magnesia), and zirconium oxide (zirconia).

In a case of fabricating the separator of the stacked type, a precursor solution is prepared that includes, for example, the polymer compound and an organic solvent, following which the precursor solution is applied on one side or opposite sides of the porous layer.

In the case where the separator of the stacked type is used also, similar effects are obtainable because lithium ions are movable between the positive electrode 11 and the negative electrode 12.

The electrolytic solution which is a liquid electrolyte is used. However, although not specifically illustrated here, an electrolyte layer which is a gel electrolyte may be used instead of the electrolytic solution.

In the battery device 10 including the electrolyte layer, the positive electrode 11 and the negative electrode 12 are stacked on each other with the separator 13 and the electrolyte layer interposed therebetween. The electrolyte layer is interposed between the positive electrode 11 and the separator 13, and between the negative electrode 12 and the separator 13.

Specifically, the electrolyte layer includes a polymer compound together with the electrolytic solution. The electrolytic solution is held by the polymer compound in the electrolyte layer. The configuration of the electrolytic solution is as described above. The polymer compound includes, for example, polyvinylidene difluoride. In a case of forming the electrolyte layer, a precursor solution is prepared that includes, for example, the electrolytic solution, the polymer compound, and an organic solvent, following which the precursor solution is applied on one side or opposite sides of each of the positive electrode 11 and the negative electrode 12.

In the case where the electrolyte layer is used also, similar effects are obtainable because lithium ions are movable between the positive electrode 11 and the negative electrode 12 via the electrolyte layer.

Next, a description is given of applications (application examples) of the above-described secondary battery according to an embodiment.

The applications of the secondary battery are not particularly limited and can include, for example, machines, equipment, instruments, apparatuses, or systems (an assembly of a plurality of pieces of equipment, for example) in which the secondary battery is usable mainly as a driving power source, an electric power storage source for electric power accumulation, or any other source. The secondary battery used as a power source may serve as a main power source or an auxiliary power source. The main power source is preferentially used regardless of the presence of any other power source. The auxiliary power source may be used in place of the main power source, or may be switched from the main power source on an as-needed basis. In a case where the secondary battery is used as the auxiliary power source, the kind of the main power source is not limited to the secondary battery.

Specific examples of the applications of the secondary battery include: electronic equipment including portable electronic equipment; portable life appliances; apparatuses for data storage; electric power tools; battery packs to be mounted as detachable power sources on, for example, laptop personal computers; medical electronic equipment; electric vehicles; and electric power storage systems. Examples of the electronic equipment include video cameras, digital still cameras, mobile phones, laptop personal computers, cordless phones, headphone stereos, portable radios, portable televisions, and portable information terminals. Examples of the portable life appliances include electric shavers. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home battery systems for accumulation of electric power for a situation such as emergency. Note that the secondary battery may have a battery structure of the above-described laminated-film type, a cylindrical type, or any other type. Further, multiple secondary batteries may be used, for example, as a battery pack or a battery module.

In particular, the battery pack and the battery module are each effectively applied to relatively large-sized equipment, etc., including an electric vehicle, an electric power storage system, and an electric power tool. The battery pack, as will be described later, may include a single battery, or may include an assembled battery. The electric vehicle is a vehicle that operates (travels) using the secondary battery as a driving power source, and may be an automobile that is additionally provided with a driving source other than the secondary battery as described above, such as a hybrid automobile. The electric power storage system is a system that uses the secondary battery as an electric power storage source. An electric power storage system for home use accumulates electric power in the secondary battery which is an electric power storage source, and the accumulated electric power may thus be utilized for using, for example, home appliances.

Some typical application examples of the secondary battery will now be described in detail. The configurations of the application examples described below are merely examples, and are appropriately modifiable.

FIG. 9 illustrates a block configuration of a battery pack. The battery pack described here is a simple battery pack (a so-called soft pack) including one secondary battery, and is to be mounted on, for example, electronic equipment typified by a smartphone.

As illustrated in FIG. 9, the battery pack includes an electric power source 41 and a circuit board 42. The circuit board 42 is coupled to the electric power source 41, and includes a positive electrode terminal 43, a negative electrode terminal 44, and a temperature detection terminal 45. The temperature detection terminal 45 is a so-called T terminal.

The electric power source 41 includes one secondary battery. The secondary battery has a positive electrode lead coupled to the positive electrode terminal 43 and a negative electrode lead coupled to the negative electrode terminal 44. The electric power source 41 is couplable to outside via the positive electrode terminal 43 and the negative electrode terminal 44, and is thus chargeable and dischargeable via the positive electrode terminal 43 and the negative electrode terminal 44. The circuit board 42 includes a controller 46, a switch 47, a thermosensitive resistive device (a positive temperature coefficient (PTC) device) 48, and a temperature detector 49. However, the PTC device 48 may be omitted.

The controller 46 includes, for example, a central processing unit (CPU) and a memory, and controls an overall operation of the battery pack. The controller 46 detects and controls a use state of the electric power source 41 on an as-needed basis.

If a battery voltage of the electric power source 41 (the secondary battery) reaches an overcharge detection voltage or an overdischarge detection voltage, the controller 46 turns off the switch 47. This prevents a charging current from flowing into a current path of the electric power source 41. In addition, if a large current flows upon charging or discharging, the controller 46 turns off the switch 47 to block the charging current. The overcharge detection voltage and the overdischarge detection voltage are not particularly limited. For example, the overcharge detection voltage is 4.2 V±0.05 V and the overdischarge detection voltage is 2.4 V±0.1 V.

The switch 47 includes, for example, a charge control switch, a discharge control switch, a charging diode, and a discharging diode. The switch 47 performs switching between coupling and decoupling between the electric power source 41 and external equipment in accordance with an instruction from the controller 46. The switch 47 includes, for example, a metal-oxide-semiconductor field-effect transistor (MOSFET) including a metal-oxide semiconductor. The charging and discharging currents are detected on the basis of an ON-resistance of the switch 47.

The temperature detector 49 includes a temperature detection device such as a thermistor. The temperature detector 49 measures a temperature of the electric power source 41 using the temperature detection terminal 45, and outputs a result of the temperature measurement to the controller 46. The result of the temperature measurement to be obtained by the temperature detector 49 is used, for example, in a case where the controller 46 performs charge/discharge control upon abnormal heat generation or in a case where the controller 46 performs a correction process upon calculating a remaining capacity.

### EXAMPLES

A description is given of Examples of the present technology below according to an embodiment.

### Experiment Examples 1 to 33

Secondary batteries (lithium-ion secondary batteries) of the laminated-film type illustrated in FIGS. 1 to 5 were fabricated, following which the secondary batteries were evaluated for their respective cyclability characteristics as described below.

### [Fabrication of Secondary Battery]

The secondary batteries were fabricated in accordance with the following procedure.

### (Fabrication of Positive Electrode)

First, 91 parts by mass of the positive electrode active material (lithium cobalt oxide ((LiCoO₂)), 3 parts by mass of the positive electrode binder (polyvinylidene difluoride), and 6 parts by mass of the positive electrode conductor (graphite) were mixed with each other to thereby obtain a positive electrode mixture. Thereafter, the positive electrode mixture was put into an organic solvent (N-methyl-2-pyrrolidone), following which the organic solvent was stirred to thereby prepare a paste positive electrode mixture slurry. Thereafter, the positive electrode mixture slurry was applied on opposite sides of the positive electrode current collector 11A (an aluminum foil having a thickness of 12 μm) by means of a coating apparatus, following which the applied positive electrode mixture slurry was dried to thereby form the positive electrode active material layers 11B. Lastly, the positive electrode active material layers 11B were compression-molded by means of a roll pressing machine. In this manner, the positive electrode active material layers 11B were formed on respective opposite sides of the positive electrode current collector 11A. Thus, the positive electrode 11 was fabricated.

### (Fabrication of Negative Electrode)

First, 93 parts by mass of the negative electrode active material (graphite) and 7 parts by mass of the negative electrode binder (polyvinylidene difluoride) were mixed with each other, to thereby obtain a negative electrode mixture. Thereafter, the negative electrode mixture was put into an organic solvent (N-methyl-2-pyrrolidone), following which the organic solvent was stirred to thereby prepare a paste negative electrode mixture slurry.

Thereafter, the negative electrode mixture slurry was applied on opposite sides of the negative electrode current collector 12A (a copper foil having a thickness of 15 μm) by means of a coating apparatus, following which the applied negative electrode mixture slurry was dried to thereby form the negative electrode active material layers 12B. In this case, the negative electrode mixture slurry was applied selectively on each of the opposite sides (the first surface M1 and the second surface M2) of the negative electrode current collector 12A to thereby form the first negative electrode active material layer 12B1 and the second negative electrode active material layer 12B2, as illustrated in FIG. 5. Thus, the negative electrode 12 including the provision part 12X (the one-side-provision part 12X1 and the both-side-provision part 12X2) and the pair of non-provision parts 12Y was formed.

Lastly, as illustrated in FIGS. 6 and 7, the negative electrode active material layers 12B were compression-molded by means of the roll pressing machine 30 (the press rollers 31 and 32). In this case, the respective pressing pressures of the press rollers 31 and 32 were varied to thereby adjust the volume density D2 (g/cm³) as described in Tables 1 and 2. Further, the press roller 32 was moved on an as-needed basis to thereby adjust each of the volume densities D1 and D3 (g/cm³) and the increase rate RD (%) as described in Tables 1 and 2. Thus, the negative electrode 12 having the volume densities D1, D2, and D3 was fabricated.

### (Preparation of Electrolytic Solution)

The electrolyte salt (lithium hexafluorophosphate (LiPF₆)) was added to a solvent (ethylene carbonate, propylene carbonate, diethyl carbonate, and propyl propionate), following which the solvent was stirred. In this case, a mixture ratio (a weight ratio) between ethylene carbonate, propylene carbonate, diethyl carbonate, and propyl propionate in the solvent was set to 30:10:40:20, and the content of the electrolyte salt with respect to the solvent was set to 1 mol/kg. The electrolyte salt was thereby dissolved in the solvent. In this manner, the electrolytic solution was prepared.

### (Assembly of Secondary Battery)

First, the positive electrode lead 14 including aluminum was welded to the positive electrode 11 (the positive electrode current collector 11A), and the negative electrode lead 15 including copper was welded to the negative electrode 12 (the negative electrode current collector 12A). Thereafter, the positive electrode 11 and the negative electrode 12 were stacked on each other with the separator 13 (a fine-porous polyethylene film having a thickness of 15 μm) interposed therebetween, following which the stack of the positive electrode 11, the negative electrode 12, and the separator 13 was wound about the winding axis J in the winding direction D to thereby fabricate the wound body. In this case, the one-side-provision part 12X1 was disposed in such a manner as to be disposed in the end part on the inner side of the winding in the winding direction D. Thereafter, the wound body was pressed by means of a pressing machine, and was thereby shaped into an elongated shape in a section intersecting the winding axis J.

Thereafter, the outer package film 20 was folded in such a manner as to sandwich the wound body placed in the depression part 20U, following which the outer edges of two sides of the outer package film 20 were thermal-fusion-bonded to each other to thereby allow the wound body to be contained inside the pouch-shaped outer package film 20. As the outer package film 20, an aluminum laminated film was used in which a fusion-bonding layer (a polypropylene film having a thickness of 30 μm), a metal layer (an aluminum foil having a thickness of 40 μm), and a surface protective layer (a nylon film having a thickness of 25 μm) were stacked in this order from the inner side.

Thereafter, the electrolytic solution was injected into the pouch-shaped outer package film 20 and thereafter, the outer edges of the remaining one side of the outer package film 20 were thermal-fusion-bonded to each other in a reduced-pressure environment. In this case, the sealing film 21 (a polypropylene film having a thickness of 5 μm) was interposed between the outer package film 20 and the positive electrode lead 14, and the sealing film 22 (a polypropylene film having a thickness of 5 μm) was interposed between the outer package film 20 and the negative electrode lead 15. The wound body was thereby impregnated with the electrolytic solution. Thus, the battery device 10 was fabricated. In this manner, the battery device was sealed in the outer package film 20, and the secondary battery was thus assembled.

### (Stabilization of Secondary Battery)

The secondary battery was charged and discharged for two cycles in an ambient temperature environment (at a temperature of 23° C.). Upon the charging, the secondary battery was charged with a constant current of 0.1 C until a battery voltage reached 4.2 V, and was thereafter charged with a constant voltage of 4.2 V until a current reached 0.05 C. Upon the discharging, the secondary battery was discharged with a constant current of 0.1 C until the battery voltage reached 3.0 V. Note that 0.1 C is a value of a current that causes a battery capacity (a theoretical capacity) to be completely discharged in 10 hours, and 0.05 C is a value of a current that causes the battery capacity to be completely discharged in 20 hours.

As a result, a film was formed on the surface of, for example, the negative electrode 12 to stabilize the state of the secondary battery. Thus, the secondary battery of the laminated-film type was completed.

Evaluation of the secondary batteries for their cyclability characteristics revealed the results described in Tables 1 and 2.

In a case of examining the cyclability characteristic, first, the secondary battery was charged and discharged in an ambient temperature environment (at a temperature of 23° C.), and a discharge capacity (a first-cycle discharge capacity) was measured. Thereafter, the secondary battery was repeatedly charged and discharged in a high-temperature environment (at a temperature of 45° C.) until the total number of cycles reached 500, and the discharge capacity (a 500th-cycle discharge capacity) was measured. Lastly, the following was calculated: capacity retention rate (%)=(500th-cycle discharge capacity/first-cycle discharge capacity)×100.

Charging and discharging conditions were similar to those in stabilizing the secondary battery described above, except that the current at the time of charging was changed to 0.3 C and the current at the time of discharging was changed to 0.5 C. Note that 0.3 C is a value of a current that causes the battery capacity to be completely discharged in 10/3 hours, and 0.5 C is a value of a current that causes the battery capacity to be completely discharged in 2 hours.

TABLE 1

| Exper- | Volume | Volume | Volume | Increase | Capacity |
|---|---|---|---|---|---|
| iment | density | density | density | rate | retention |
| example | D1 (g/cm³) | D3 (g/cm³) | D2 (g/cm³) | RD (%) | rate (%) |
| 1 | 1.520 | 1.480 | 1.480 | 2.7 | 83 |
| 2 | 1.520 | 1.520 | | 2.7 | 84 |
| 3 | 1.520 | 1.550 | | 2.7 | 83 |
| 4 | 1.525 | 1.530 | | 3.0 | 82 |
| 5 | 1.540 | 1.540 | | 4.1 | 80 |
| 6 | 1.530 | 1.500 | 1.500 | 2.0 | 84 |
| 7 | 1.530 | 1.530 | | 2.0 | 87 |
| 8 | 1.530 | 1.550 | | 2.0 | 86 |
| 9 | 1.545 | 1.550 | | 3.0 | 82 |
| 10 | 1.560 | 1.560 | | 4.0 | 80 |
| 11 | 1.640 | 1.600 | 1.600 | 2.5 | 85 |
| 12 | 1.640 | 1.640 | | 2.5 | 87 |
| 13 | 1.640 | 1.700 | | 2.5 | 86 |
| 14 | 1.648 | 1.648 | | 3.0 | 83 |
| 15 | 1.670 | 1.670 | | 4.4 | 80 |
| 16 | 1.740 | 1.700 | 1.700 | 2.4 | 85 |
| 17 | 1.740 | 1.740 | | 2.4 | 88 |
| 18 | 1.740 | 1.770 | | 2.4 | 87 |
| 19 | 1.751 | 1.751 | | 3.0 | 83 |
| 20 | 1.770 | 1.770 | | 4.1 | 80 |

TABLE 2

| Exper- | Volume | Volume | Volume | Increase | Capacity |
|---|---|---|---|---|---|
| iment | density | density | density | rate | retention |
| example | D1 (g/cm³) | D3 (g/cm³) | D2 (g/cm³) | RD (%) | rate (%) |
| 21 | 1.810 | 1.770 | 1.770 | 2.3 | 84 |
| 22 | 1.810 | 1.810 | | 2.3 | 86 |
| 23 | 1.810 | 1.850 | | 2.3 | 85 |
| 24 | 1.823 | 1.823 | | 3.0 | 82 |
| 25 | 1.840 | 1.840 | | 4.0 | 80 |
| 26 | 1.840 | 1.800 | 1.800 | 2.2 | 83 |
| 27 | 1.840 | 1.840 | | 2.2 | 84 |
| 28 | 1.840 | 1.870 | | 2.2 | 82 |
| 29 | 1.854 | 1.854 | | 3.0 | 81 |
| 30 | 1.870 | 1.870 | | 3.9 | 80 |
| 31 | 1.600 | 1.600 | 1.600 | 0 | 76 |
| 32 | 1.550 | 1.600 | | −3.1 | 75 |
| 33 | 1.550 | 1.640 | | −3.1 | 72 |

As described in Tables 1 and 2, the cyclability characteristic of the secondary battery varied greatly depending on the configuration of the negative electrode 12 (the volume densities D1, D2, and D3 and the increase rate RD).

Specifically, the capacity retention rate increased in a case where the volume density D1 was higher than the volume density D2 (Experiment examples 1 to 30) as compared with a case where the volume density D1 was lower than or equal to the volume density D2 (Experiment examples 31 to 33).

In particular, the following tendencies were obtained in the case where the volume density D1 was higher than the volume density D2. First, in a case where the volume density D3 was higher than or equal to the volume density D2, a high capacity retention rate was obtained. In this case, the capacity retention rate further increased if the volume density D3 was lower than or equal to the volume density D1. Second, in a case where the volume density D2 was within a range from 1.500 g/cm³ to 1.770 g/cm³ both inclusive, the capacity retention rate further increased. Third, in a case where the increase rate RD was greater than 0% and less than or equal to 3.0%, a high capacity retention rate was obtained.

Based upon the results presented in Tables 1 and 2, a high capacity retention rate was obtained in a case where the negative electrode 12 included the one-side-provision part 12X1 and the both-side-provision part 12X2, and where the volume density D1 of the negative electrode active material layer 12B in the one-side-provision part 12X1 was higher than the volume density D2 of the negative electrode active material layer 12B in the both-side-provision part 12X2. Accordingly, a superior cyclability characteristic of the secondary battery was obtained.

Although the present technology has been described herein, the configuration of the present technology is not limited to the description, and is therefore modifiable in a variety of suitable ways.

For example, although the description relates to the case where the secondary battery has a battery structure of the laminated-film type, the battery structure is not particularly limited, and may thus be of any other type such as a cylindrical type, a prismatic type, a coin type, or a button type.

Further, although the description relates to the case where the battery device has a wound-type device structure, the device structure of the battery device is not particularly limited, and may thus be any other device structure such as a stacked-type device structure in which the electrodes (the positive electrode and the negative electrode) are stacked, or a zigzag-folded-type device structure in which the electrodes (the positive electrode and the negative electrode) are folded in a zigzag manner.

Further, although the description relates to the case where the electrode reactant is lithium, the electrode reactant is not particularly limited. For example, as described herein, the electrode reactant may be another alkali metal such as sodium or potassium, or may be an alkaline earth metal such as beryllium, magnesium, or calcium. Further, the electrode reactant may be another light metal such as aluminum.

The effects described herein are mere examples, and effects of the present technology are therefore not limited to those described herein. Accordingly, the present technology may achieve any other suitable effect.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode including a negative electrode current collector and a negative electrode active material layer; and
an electrolytic solution, wherein
the negative electrode includes
a one-side-provision part in which the negative electrode active material layer is provided only on one of opposite sides of the negative electrode current collector, and
a both-side-provision part which is adjacent to the one-side-provision part, and in which the negative electrode active material layer is provided on each of the opposite sides of the negative electrode current collector, and
a first volume density of the negative electrode active material layer in the one-side-provision part is higher than a second volume density of the negative electrode active material layer in the both-side-provision part.

2. The secondary battery according to claim 1, wherein a third volume density of the negative electrode active material layer at a position at which the both-side-provision part is adjacent to the one-side-provision part is higher than or equal to the second volume density.

3. The secondary battery according to claim 2, wherein the third volume density is lower than or equal to the first volume density.

4. The secondary battery according to claim 3, wherein the second volume density is higher than or equal to 1.500 grams per cubic centimeter and lower than or equal to 1.770 grams per cubic centimeter.

5. The secondary battery according to claim 1, wherein an increase rate represented by Expression (1) is greater than 0 percent and less than or equal to 3.0 percent,
RD=(D1/D2−1)×100 (1)
where
RD is the increase rate (percent),
D1 is the first volume density (gram per cubic centimeter), and
D2 is the second volume density (gram per cubic centimeter).

6. The secondary battery according to claim 1, wherein
the negative electrode is wound, and
the one-side-provision part is positioned in an end part on an inner side of winding of the negative electrode.

7. The secondary battery according to claim 6, wherein
the secondary battery includes a battery device in which the positive electrode and the negative electrode are wound about a winding axis,
a section of the battery device intersecting the winding axis has an elongated shape defined by a major axis and a minor axis,
the negative electrode includes a negative electrode extending part in the end part on the inner side of the winding of the negative electrode, the negative electrode extending part extending in a direction of the major axis, and
the negative electrode extending part includes the one-side-provision part.

8. The secondary battery according to claim 1, wherein the secondary battery comprises a lithium-ion secondary battery.

9. A negative electrode for a secondary battery, the negative electrode comprising:
a negative electrode current collector; and
a negative electrode active material layer, wherein
the negative electrode includes
a one-side-provision part in which the negative electrode active material layer is provided only on one of opposite sides of the negative electrode current collector, and
a both-side-provision part which is adjacent to the one-side-provision part, and in which the negative electrode active material layer is provided on each of the opposite sides of the negative electrode current collector, and
a first volume density of the negative electrode active material layer in the one-side-provision part is higher than a second volume density of the negative electrode active material layer in the both-side-provision part.
